(19) United States
(12) Patent Application Publication
(10) Pub. No.: US 2008/0285283 A1
(43) Pub. Date: Nov. 20, 2008

(54) Spiral Shaped, with Jointed Rigid Arms, Foldable Lamp

(76) Inventors: Claudio Marra, Roma (IT); Andrea Marra, Roma (IT)

Correspondence Address: NIXON & VANDERHYE, PC, 901 NORTH GLEBE ROAD, 11TH FLOOR, ARLINGTON, VA, 22203, US

(21) Appl. No.: 10/586,468

(22) PCT Filed: Jan. 18, 2005
(86) PCT No.: PCT/IT2005/000023

§ 371 Date: Jul. 28, 2008

(30) Foreign Application Priority Data
Jan. 19, 2004 (IT) RM 2004 U 000006

(51) Int. Cl. F21S 2/00; F21V 19/00

(52) U.S. Cl. 362/257; 362/382

(57) ABSTRACT

The present invention concerns a lamp with jointed rigid arms forming, in the folded position, a spiral shape, that can be a circular spiral or a polygonal spiral: see FIG. 1A, 2, 12, 13, 14, 15, 16. The arms are joined one another by means of joints, see FIG. 3, housed and locked inside the arms, and that consist of cylindrical hinges provided with brakes having an adjustable braking moment, see FIGS. 3, 4 and 5. This allows to turn at will the arms one another and to keep them still in the wanted position. The joints have a pass through hole inside, see FIGS. 3, 7 and 8, to permit the passing of the electric wires or of the optical fibres.

### TECHNICAL FIELD

This invention relates to a lamp with jointed rigid arms, that can be fitted up to many different mounting kinds: a wall mounted, a ceiling bracket, a table base, a floor base and so on.

It provides characteristics of great versatility because it is also extendable in many ways, and in a large dimension too, in comparison with the compact folded shape, that is a spiral shape. It can be used conveniently at home, office, and in every place where it is possible to take advantage of its versatility.

### BACKGROUND ART

Lamps with jointed rigid arms already exist on the market, but they have various limits and disadvantages: either they have only one rigid arm or, if they have more, they all lay in the same plane having, at the most, one ball-and-socket joint or one hinge at the base that allows turning the whole lamp. This permits only a limited flexibility of the extension of the lamp and does not allow limiting its encumbrance in the folded position, particularly if there are long arms.

There are also lamps that have only one arm, which is made by a wrinkled semi-rigid rod, but they are shorter, not foldable in a compact and aesthetically valid design, as it happens for the present invention, of which a detailed description follows.

### DISCLOSURE OF INVENTION

The present invention concerns a lamp with jointed rigid arms that, in the folded shape, form in sequence a spiral shape, that can be a circular spiral or a polygonal spiral: see FIG. 1A, 2, 12, 13, 14, 15. The polygon with the highest number of sides that is represented is the hexagon, however similarly it is possible to carry out a polygon with higher number of sides, but with heavier weight and cost.

The structure of the lamp is a mechanical system with n degrees of freedom, where n is the number of joints that join one to another the n+1 stiff arms in a sequence. Setting as the origin of the angles of rotation between each couple of arms, the angles corresponding with the folded position, see FIG. 1A, the numberless configurations that the system can achieve, can be located by the value of the n angles α₁, α₂, αₙ, that can be set as one likes among the n+1 arms of the lamp, except obviously those arrangements of angles that would cause the collision between arms. In order that all the configurations set by the user would result of equilibrium for the system, and therefore the lamp would remain in the desired position, it is needed that the maximum twisting moment in each one of the n joints, for all the possible configurations, would result lower than the braking moment that each joint can exert towards the consecutive arms that it connects. This limitation characterizes the lamp whichever the chosen shape may be, either circular spiral or polygonal spiral with n sides.

At the same time the braking moment that each joint exerts has not to be too high, so that the user could manually modify the shape of the lamp easily and without the help of a tool. To carry out this aim the weight of the system must be limited, so that the maximum twisting moment could be low, using light materials and hollow arms. The joint between two consecutive arms therefore has to be a joint with “adjustable braking moment”, that can be carried out in many ways, one of which, particularly simple to be made, is the one chosen in this invention.

The joint moreover must allow the passing of the electric wires to supply the light bulb, across a pass through hole, as made in the present case, n^{o} 1—FIG. 3, or, eventually, by the use of “sliding contacts”, typical of the electrical connections of the rotating axes.

The description of the utilized joint, see FIG. 3-4-5, will make reference to a portion of the joint, n^{o} 2—FIG. 3, housed and locked in the arm n, n^{o} 3 FIG. 4-5, that can be supposed, in order to describe the only joint, as fixed arm, and a portion of the joint, n^{o} 4—FIG. 3, housed and locked in the arm n+1, n^{o} 5—FIG. 4-5, that can be supposed, still in order to describe the only joint, as movable arm. The fixed portion of the joint, housed and locked in the arm n, consists of a four elements set:
A cylindrical component, n^{o} 2—FIG. 3, that, parallel to the axis of the cylinder, provided with four holes, of which a bigger one at the centre, n^{o} 1—FIG. 3, for the pass-through of the electric wires or optic fibre, and three smaller holes, n^{o} 6—FIG. 3, made to allow the passing of the three screws, n^{o} 7—FIG. 3, for the join of the same joint, that are placed at a certain distance from the centre and uniformly distributed along the 360 degrees. In the said component, apart from the four holes just described, two parts that have different external diameter are distinguishable, n^{o} 2—FIG. 3. In particular the part that has a narrowing of the diameter, n^{o} 2b—FIG. 3, is made so that can be joined with the movable portion of the joint, n^{o} 4—FIG. 3, housed and locked into the arm n+1, n^{o} 5—FIG. 4-5; substantially the outside diameter of the fixed portion in its narrow part, n^{o} 2b—FIG. 3, matches the inside diameter of the movable portion of the joint, n^{o} 4—FIG. 3, further described. In order to lock the fixed portion of the joint, n^{o} 2—FIG. 4, to the fixed arm n, n^{o} 3 FIG. 4, the fixed portion of the joint is provided with a blind hole, n^{o} 8—FIG. 4, in which, with the purpose of locking an fixing, a grub screw goes to bind, n^{o} 9—FIG. 4, preventing the reciprocal movement and the unthreading of the fixed portion of the joint out of the fixed arm n.
A joint disc, n^{o} 10—FIG. 3, thick enough to ensure a good stiffness, which is provided with four holes parallel to the axis of the disc, n^{o} 11—FIG. 3, corresponding to the holes made in the cylindrical component above described, n^{o} 1 and 6—FIG. 3, and with the same purpose to allow the pass-through of the electric wires or optic fibre and of the screws;
three screws of steel, n^{o} 7—FIG. 3, that have to be inserted into the predisposed holes of the cylindrical component, n^{o} 1 and 6—FIG. 3, and of the joint disc, n^{o} 10—FIG. 3, screwed with self-locking nuts, n^{o} 12—FIG. 3;
a rubber washer, n^{o} 13—FIG. 3, having the outside diameter equal to the largest diameter of the cylindrical component, n^{o} 2a—FIG. 3, and with the inside diameter equal to the smallest diameter of the cylindrical component, n^{o} 2b—FIG. 3. The said washer carries on two functions: the first one is to increase the friction coefficient in the contact between the movable portion of the joint, n^{o} 4—FIG. 3, and the fixed portion, n^{o} 2—FIG. 3, the second one is to work as elastic compressible element so that it makes possible to adjust the frictional force, and consequently the braking moment, produced between the movable and the fixed portion simply screwing up more or less the three screws, n^{o} 7—FIG. 3, that keep connected the movable portion to the fixed portion of the joint.

The movable portion of the joint, n^{o} 4—FIG. 3, housed and locked into the arm n+1, n^{o} 5—FIG. 4-5, is constituted by an empty cylinder that, like the rubber washer above described, has the outside diameter equal to the largest diameter of the fixed cylindrical component, n^{o} 2a—FIG. 3, housed and locked into the arm n, n^{o} 3—FIG. 4-5, and the inside diameter equal to the smallest diameter of the same cylindrical component, n^{o} 2b—FIG. 3. The length of the empty cylinder, n^{o} 4—FIG. 3, is equal to or greater than the length of the narrow portion of the fixed component, n^{o} 2b—FIG. 3, so that, considering also the thickness of the rubber washer, there would not be contact between the joint disc, n^{o} 10—FIG. 3, and the fixed cylindrical component, n^{o} 2—FIG. 3. Therefore the joint disc, pressing only the movable portion of the joint, n^{o} 4—FIG. 3, by means of it compresses the rubber washer that, being elastic, allows to adjust, with a stronger or lighter tightening of the nuts, the frictional force and therefore the braking moment produced between the movable and the fixed portion of the joint. In order to keep locked the movable portion of the joint, n^{o} 4—FIG. 3, to the movable arm n+1, n^{o} 5—FIG. 4-5, the movable portion of the joint is provided with a blind hole, n^{o} 14—FIG. 4-5, in which, with the purpose of locking and fixing, a grub screw goes to bind, n^{o} 15—FIG. 4-5, preventing the reciprocal movement and the unthreading of the movable portion of the joint out of the fixed arm n+1.

In FIG. 4-5 are shown, both in axonometric and in vertical section drawing, two consecutive arms joined each other by means of the above described joint, either in correspondence of a null angle between the arms, FIG. 4, or in correspondence of a rotation of 90 degrees between the two arms, FIG. 5. Particularly can be remarked:
the fixed portions of the joint, n^{o} 2-7-10-13, housed and locked to the arm n, n^{o} 3, and the movable portion of the joint, n^{o} 4, housed and locked to the arm n+1, n^{o} 5;
the threaded holes, n^{o} 3a-5a, made in the arms for the screwing of the grub screws, n^{o} 9-15;
the seats drawn in the arms, n^{o} 3-5, for the coupling between the arm and the joint, consisting of cylindrical holes with the inside diameter equal to the outside diameter of the fixed and movable portions of the joint, n^{o} 3b-5b;
in the vertical section drawing of FIG. 5, the grub screw, n^{o} 15, in the movable arm n+1 that, being rotated of 90 degrees with both the very arm and the movable portion of the joint, is visible in the section drawing and appears, as necessary to ensure the fastening, on one side inserted into the blind hole, n^{o} 14, drawn in the movable portion of the joint, n^{o} 4, and on the other side tight screwed in the threaded hole of the movable arm n+1, n^{o} 5a.

The lamp can be carried out with an arbitrary number of arms, within the possible structural limits, and, according to the length and the number of them, can be extended in several ways, constituting a mechanical system with a number of degrees of freedom equal to the number of the joints, whose equilibrium positions are subordinated to the adjustable forces of friction in the various joints. Proceeding to describe at first the model with circular spiral form, the simplest case is the one where every arm is extended as far as 180 degrees of development of the spiral, see FIG. 6, keeping the mating surfaces of the arms, in correspondence of the joint, n^{o} 16—FIG. 6, all in the same plane, n^{o} 17—FIG. 6. Another case of which is possible to take advantage is the one where every arm is extended as far as 90 degrees of development of the spiral, see FIG. 1b-10-11, that allows to overcome various obstacles and extends the variety of the possible extensions. Similarly the lamp may be carried out with an extension of the arms of 120 degrees or any other angle, also adopting different angles of extension among the various arms of the same lamp. The transverse sectional view of each arm is circular, n^{o} 18-19—FIG. 7, with the radius decreasing with the development of the spiral, in order to optimize the geometry and the structural aspects of the lamp. It is also possible to adopt a circular section with the radius that keeps constant with the development of the lamp, but with the detriment of the aforesaid advantages. The said circular section lets, however the arms would be oriented, the development of the lamp happens with the lack of sharp corners and, from an aesthetical point of view, with continuity, that is without the evidence of the dissection of the arms in correspondence of the joints. Nothing forbids adopting a different shape of the transverse section, but loosing this functional and aesthetical advantage. At the extremity of the lamp is placed the lighting set, n^{o} 20—FIG. 6-9-10-11, that contains the light bulb, n^{o} 21—FIG. 9, or the light emitting diodes, or, in case of use of optical fibre, the light diffuser. The lighting set may have many shapes and, in the proposed model, it consists of a spherical bowl with reflecting inside surface, n^{o} 22—FIG. 9, with, if necessary, a light diffuser. The electric wires, n^{o} 23—FIG. 7-8, for the light bulb supply, pass through the inside of the arms and in particular through the arranged cavities of the joints, n^{o} 1—FIG. 8. The same path, instead of the electric wires, may be covered by an optic fibre, with the advantage that it can be cut off in correspondence of the joints, in order to avoid problems for its twisting. In this case the source of light, whether it is a light bulb or light emitting diodes or other, may be put inside the first arm. The lamp can be fitted up to many kinds of mountings, corresponding to the most common mountings: for instance it can be set up to a wall bearing or a ceiling bracket, a table bracket or base or to a floor basement with convenient weight and shape such as to bear the maximum bending stress of the lamp and avoid the upsetting.

Going to describe the model with “polygonal” spiral shape, see FIG. 2, 12, 13, 14, 15, the previous description is valid except for the following features: 1°) the arms have the shape of truncated cone or cylinder and, in the folded position, they form in sequence, each other, angles of 120° in the “triangular” case, 90° in the square case, 72° in the pentagonal case and so on for the subsequent polygons, agreeing with the general formula “φ=180° (n−2)/n”, where φ is the angle between two consecutive sides of the regular polygon and n is the number of its sides. 2°) the transverse orthogonal section of each arm may have the most various shapes and in particular polygonal, circular or elliptical shape. The last one has particular advantages in the case the ellipse have a such degree of eccentricity, that the oblique sections of the extremities of the same arms have circular shape, see section c-c and section d-d—FIG. 12-13-14-15: in case the arms have the shape of a truncated cone, this happens in agreement with the formula “a/b=sen(α−β)sen(β+α)/(sen α cos² β)”, where a and b are respectively the minor and the major axis of the above mentioned ellipse, while, considered a longitudinal section of the virtual prolongation of an arm up to the vertex of the cone, α is the smallest angle between the plane of the extreme section of the arm and the axis of the cone, and β is half of the vertex angle; in the case instead the arms have cylindrical shape, it happens in agreement with the formula “a/b=sen α”, where a and b are respectively the minor and the major axis of the above mentioned ellipse, and α is half of the inside angle between two consecutive arms; all this consequently provides a particular value, both functional and aesthetical: the safety for the hands of who goes to orient the lamp, that cannot go to be included between the boundary surfaces of the arms, being wounded in a scissors like action, thanks to the continuity of the outside surface of the lamp due to the non-evidence of the dissection of the arms in correspondence of the joints, for any angle each arm may form with the adjoining arms, and, at the same time an impression of general continuity of all the extension of the lamp. 3°) The last section, that supports the light bulb, consists of a bowl, with reflecting inside surface, that has the shape of a pyramid with triangular base in the “triangular” case, with square base in the “quadrangular” case, with pentagonal base in the “pentagonal” case and so on for the subsequent polygons.

### BRIEF DESCRIPTION OF DRAWINGS

FIG. 1A is a side view of the lamp of the title in the folded position, where the kind of spiral is a circular spiral, where every arm is extended as far as 90 degrees of development of the spiral, having the cross orthogonal sections of the arms of circular shape with the radius that decreases with the development of the spiral;

FIG. 1B is a front view of the lamp of FIG. 1A set in a particular configuration of descending spiral;

FIG. 2 is a side view of the lamp of the title in the folded position, where the kind of spiral is a hexagonal spiral;

FIG. 3 is an axonometric view of an assembled joint and of all the distinct parts of a joint;

FIG. 4 is a couple of consecutive arms of the lamp of FIG. 1, turned in position of null angle, and represented in two different ways: a side view of the two arms that are separated, with, in the middle, the unthreaded joint and the grub screws, and a “partly side view-partly longitudinal section view” of the two arms that are joined, with the joint, in the middle, housed and locked in section view too);

FIG. 5 is a couple of consecutive arms, as in FIG. 4, but turned in position of 90 degrees angle, with the grub screws shown in different positions and visible in the section view too;

FIG. 6 is a side view of the lamp of FIG. 1, but in an extended position and where every arm is extended as far as 180 degrees of development of the spiral;

FIG. 7 is a side view of an arm of the lamp of FIG. 1, with the joints housed and locked in each extremity and the electric wires that come out of them. There are also two cross orthogonal section views;

FIG. 8 is a longitudinal section view of the arm of FIG. 7;

FIG. 9 is the lighting set of the lamp of FIG. 1, that consists of a spherical bowl with reflecting inside surface and with the light bulb;

FIG. 10 is a side view of the lamp of FIG. 1A set in a particular configuration;

FIG. 11 is a side view of the lamp of FIG. 1A set in another particular configuration;

FIG. 12 is a side view of the lamp of the title in the folded position, where the kind of spiral is a circular spiral, where every arm is extended as far as 180 degrees of development of the spiral, having the cross orthogonal sections of the arms of circular shape with the radius that keeps constant with the development of the spiral;

FIG. 13 is a side view of the lamp of the title in the folded position, where the kind of spiral is a triangular spiral, having the cross orthogonal sections of the arms of elliptical shape, see C-C section, with such degree of eccentricity that the oblique sections of the extremities of the same arms have circular shape, see D-D section;

FIG. 14 is a side view of the lamp of the title in the folded position, where the kind of spiral is a square spiral, having the cross orthogonal sections of the arms of elliptical shape, see C-C section, with such degree of eccentricity that the oblique sections of the extremities of the same arms have circular shape, see D-D section;

FIG. 15 is a side view of the lamp of the title in the folded position, where the kind of spiral is a pentagonal spiral, having the cross orthogonal sections of the arms of elliptical shape, see C-C section, with such degree of eccentricity that the oblique sections of the extremities of the same arms have circular shape, see D-D section;

FIG. 16 is a side view of the lamp of the title in the folded position, where the kind of spiral is a hexagonal spiral, having the cross orthogonal sections of the arms of elliptical shape, see C-C section, with such degree of eccentricity that the oblique sections of the extremities of the same arms have circular shape, see D-D section;

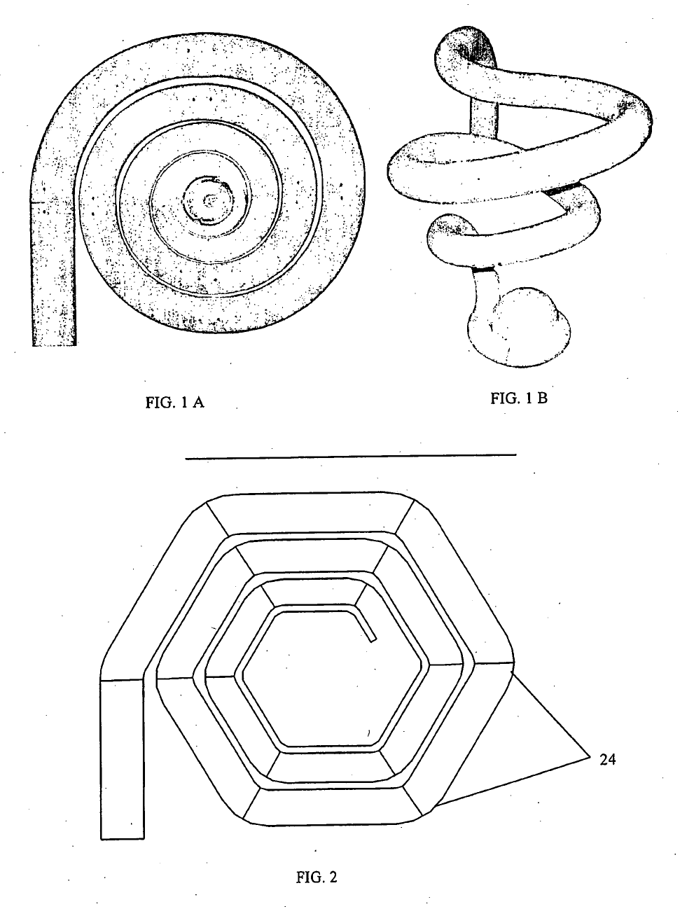

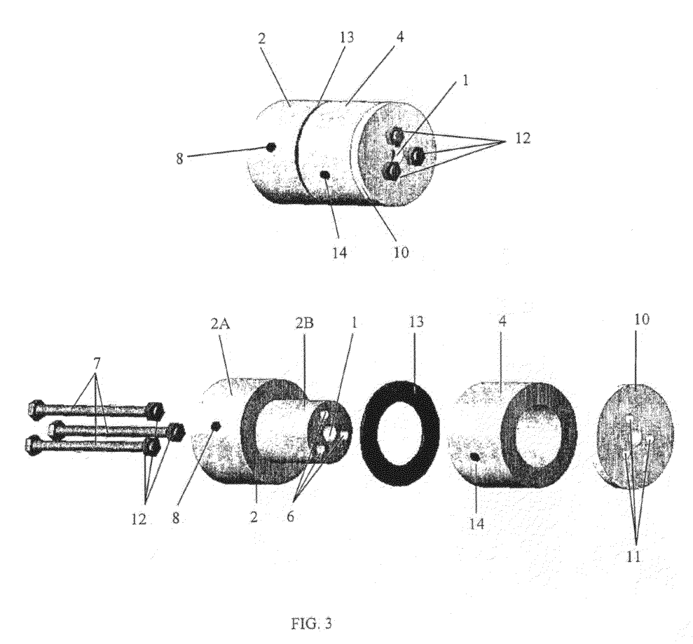

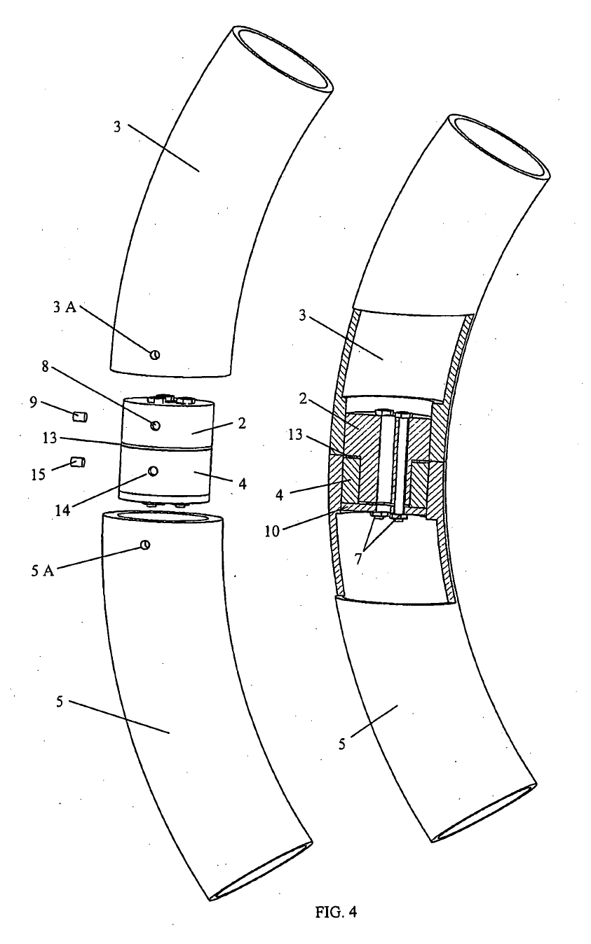

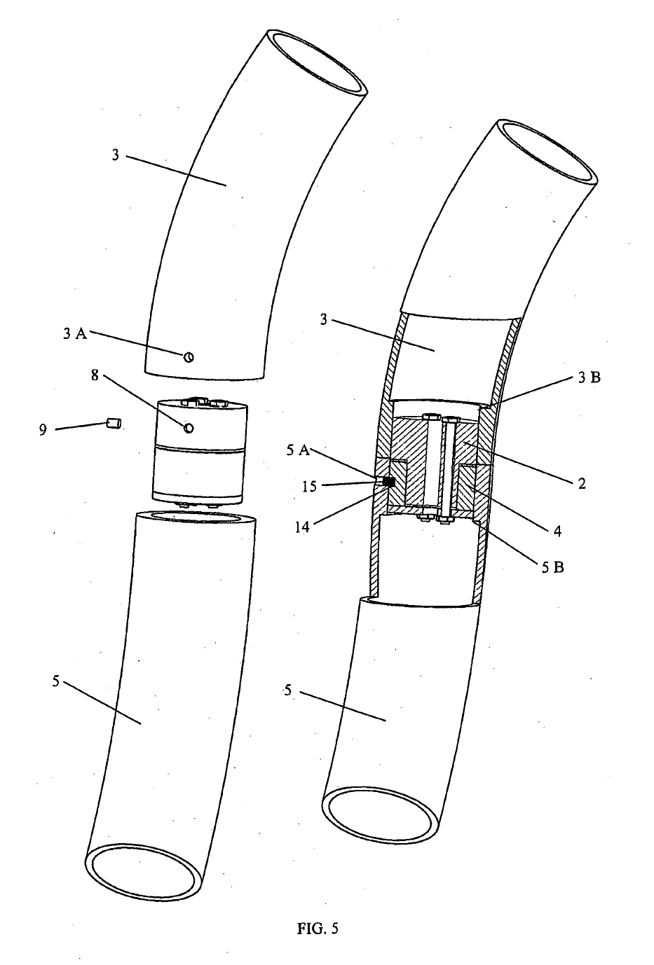

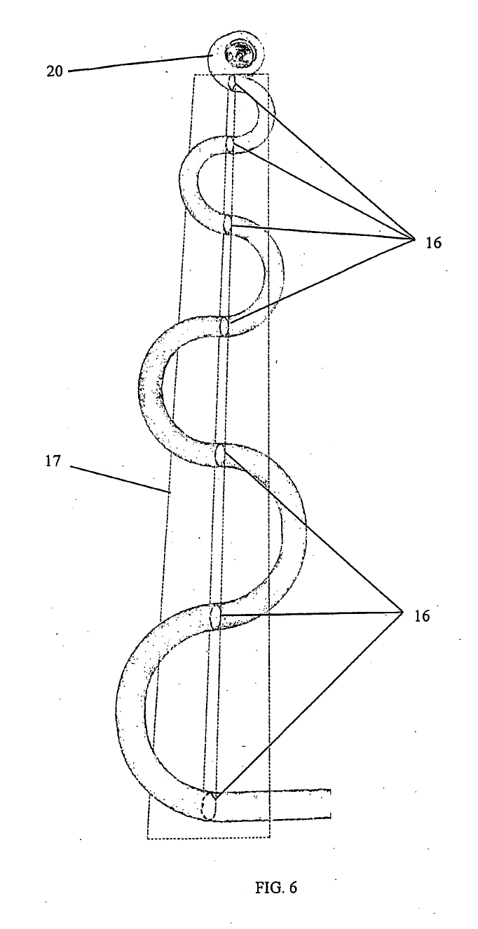

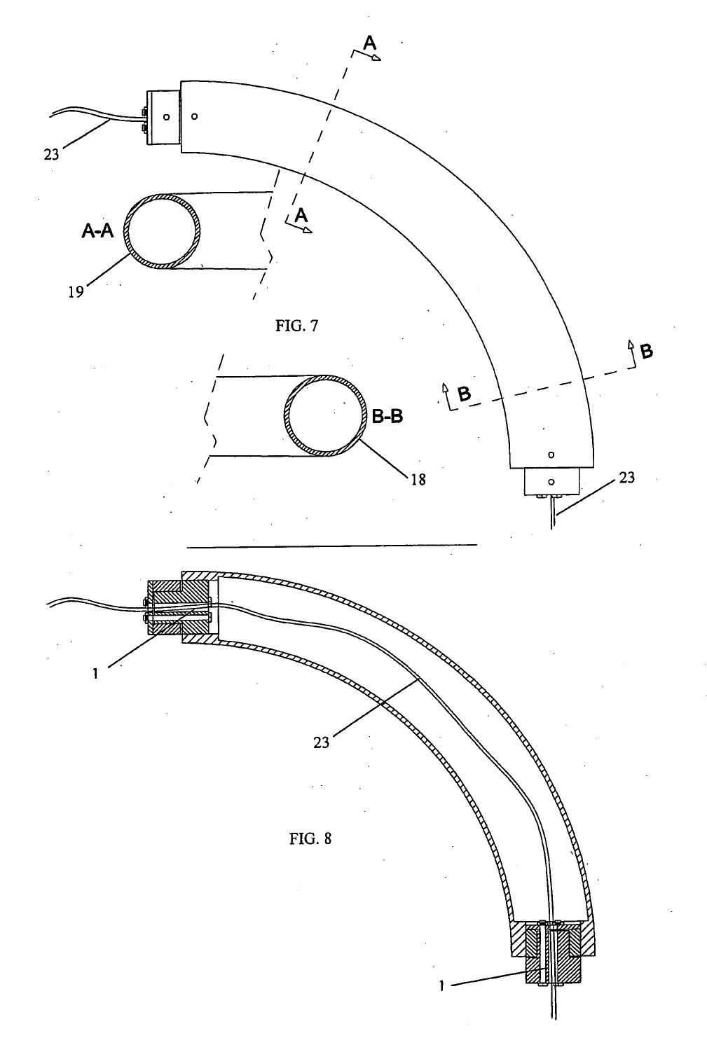

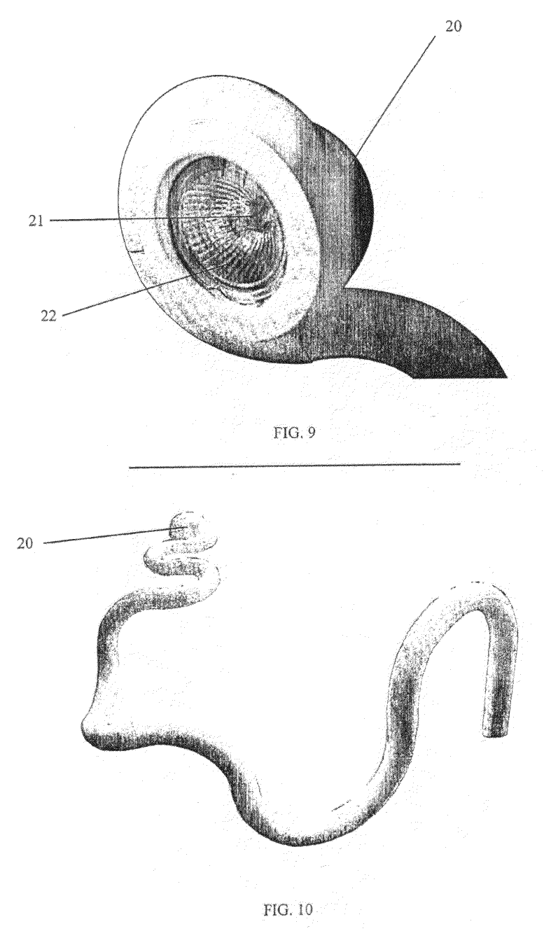

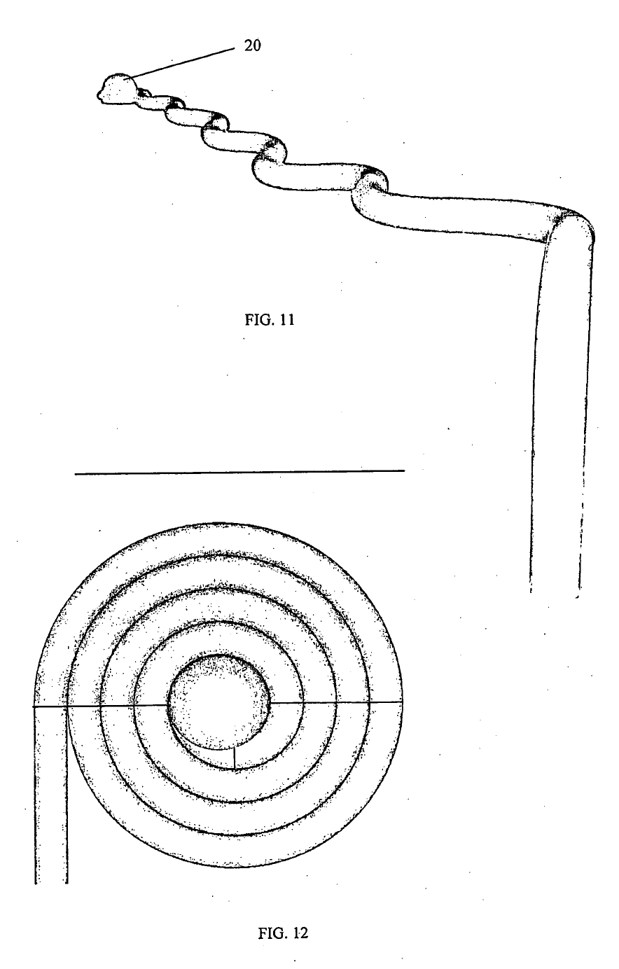

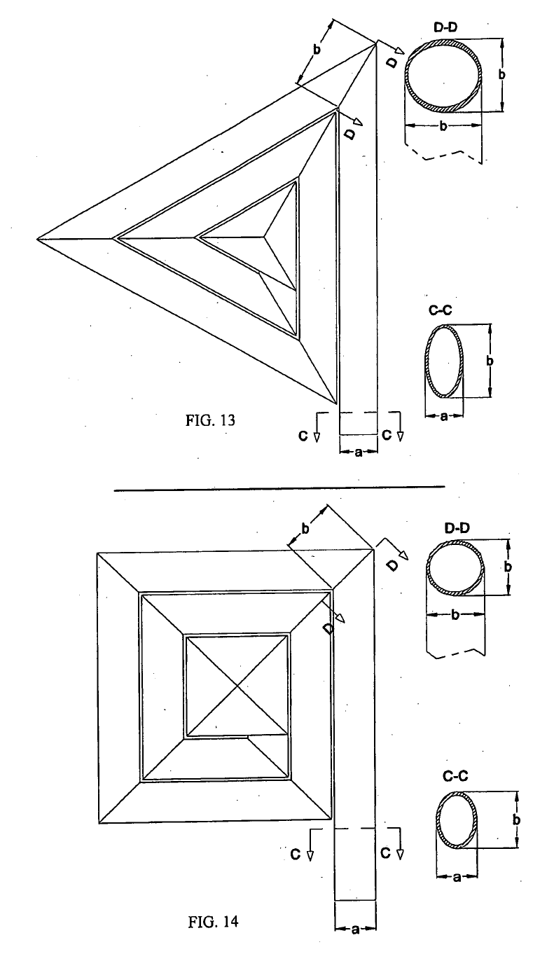

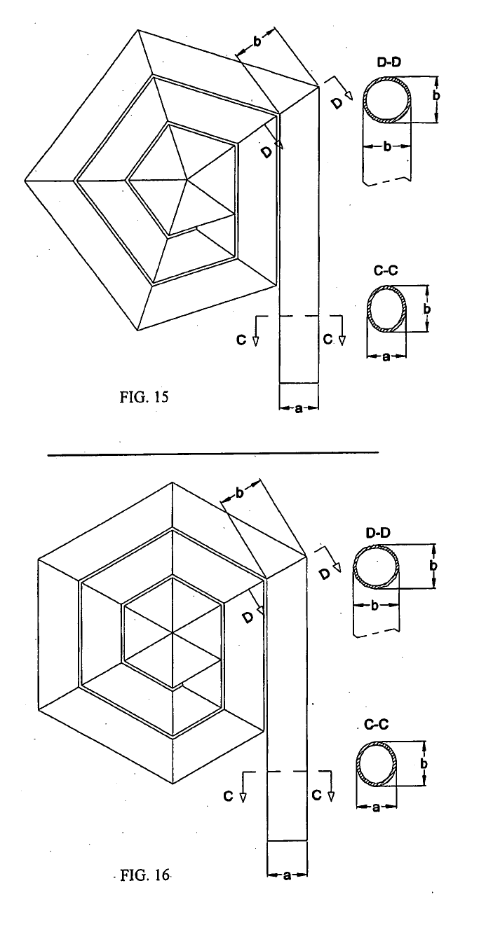

1-14. (canceled)

15. Lamp having a supporting structure comprising a plurality of rigid arms disposed in succession so as to form a circular or a polygonal spiral, each arm being joined to the adjacent ones at respective ends by a joint consisting of a cylindrical hinge provided with an adjustable braking moment, so as to allow the raising and the lowering of the lamp from a flat configuration to a raised or extended configuration and to keep the supporting structure still in a desired position.

16. Lamp according to claim 15, wherein said spiral is circular, having a curvature radius progressively decreasing from a periphery of the structure.

17. Lamp according to claim 15, wherein the spiral is a triangular, square, pentagonal or hexagonal.

18. Lamp according to claim 16, wherein the orthogonal section of each arm is circular with a constant radius along the development of the spiral.

19. Lamp according to claim 16, wherein the orthogonal section of each arm is circular with a decreasing radius along the development of the spiral.

20. Lamp according to claim 17, wherein the orthogonal section of each arm is elliptical having a degree of eccentricity so as to produce an oblique section, at the ends of each arms, having a circular shape.

21. Lamp according to claim 15, wherein each arm is hollow, so as to allow the passage of electrical wires and/or optical fibres.

22. Lamp according to claim 15, having a light source at the inner end of the spiral supporting structure.

23. Lamp according to claim 22, wherein the light source comprises at least one light bulb and/or one light emitting diode.

24. Lamp according to claim 15, comprising a bracket, for securing the supporting structure to a wall or to a ceiling, or a basement for resting the supporting structure on a table or on the floor.
